(19) United States
(12) Patent Application Publication
(10) Pub. No.: US 2015/0033917 A1
(43) Pub. Date: Feb. 5, 2015

(54) Torque Multiplier

(71) Applicant: XUAN-REN CHEN, Taichung City (TW)

(72) Inventor: XUAN-REN CHEN, Taichung City (TW)

(21) Appl. No.: 13/958,617

(22) Filed: Aug. 5, 2013

(51) Int. Cl. B25B 23/142; B25B 13/48; B25B 23/00

(52) U.S. Cl. CPC B25B 23/1422; B25B 23/0035; B25B 13/48
USPC 81/479

(57) ABSTRACT

A torque multiplier includes an input element, an output element, a multiplying unit, a measurement unit and a display. The input element is used for connection to a tool operable for exerting torque. The output element is used for connection to an object to be driven by the tool. The multiplying unit is used for connecting the input element to the output element and turning a lower value of torque at the input element to a higher value of torque at the output element. The measurement unit is used for measuring the higher value of torque and accordingly sending a wireless signal. The display is used for receiving the wireless signal and accordingly showing the higher value of torque.

### BACKGROUND OF INVENTION

1. Field of Invention

The present invention relates to a wrench and, more particularly, to a torque multiplier for a wrench.

2. Related Prior Art

There have been various manual, electric and pneumatic tools for driving fasteners such as threaded bolts and nut for holding components together to form a construction. Each manual, electric or pneumatic tool is designed to provide a certain value of torque.

Sometimes, it is necessary to exert on a fastener a value of torque higher than the designed value. In such a case, a torque multiplier can be used together with a manual, electric or pneumatic tool.

Torque multipliers can be found in U.S. Pat. Nos. 3,861,244, 5,176,047, 5,616,095, 6,012,359, 6,742,417, 6,810,571 and 7,284,463 and Taiwanese Patent No. 195258 and M386143. A torque multiplier may be designed to provide a ratio such as 5:1 and 15:1 for multiplying the designed value of torque that can be exerted by a manual, electric or pneumatic tool. However, loss of power in the torque multiplier is inevitable, and an actual ratio achievable by the torque multiplier is lower than the designed ratio. Hence, the combination of the manual, electric or pneumatic tool with the torque multiplier fails to provide a multiplied value of torque as desired. Such shortage of torque is dangerous since fasteners might not be tightened enough to hold components together firmly and a structure that consists of the components might collapse.

Therefore, the present invention is intended to obviate or at least alleviate the problems encountered in prior art.

### SUMMARY OF INVENTION

It is the primary objective of the present invention to provide a torque multiplier capable of showing the value of torque exerted therewith.

To achieve the foregoing objective, the torque multiplier includes an input element, an output element, a multiplying unit, a measurement unit and a display. The input element is used for connection to a tool operable for exerting torque. The output element is used for connection to an object to be driven by the tool. The multiplying unit is used for connecting the input element to the output element and turning a lower value of torque at the input element to a higher value of torque at the output element. The measurement unit is used for measuring the higher value of torque and accordingly sending a wireless signal. The display is used for receiving the wireless signal and accordingly showing the higher value of torque.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a side view of a torque multiplier according to the preferred embodiment of the present invention;

FIG. 2 is a side view of a system including the torque multiplier shown in FIG. 1; and

FIG. 3 is a cross-sectional view of the torque multiplier of FIG. 1.

### DETAILED DESCRIPTION OF PREFERRED EMBODIMENT

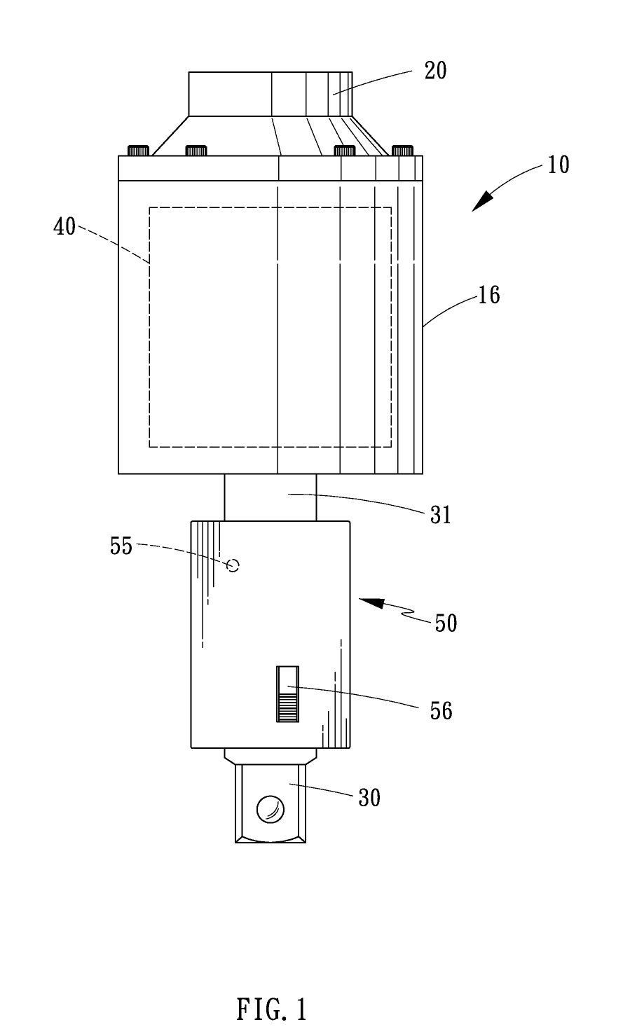

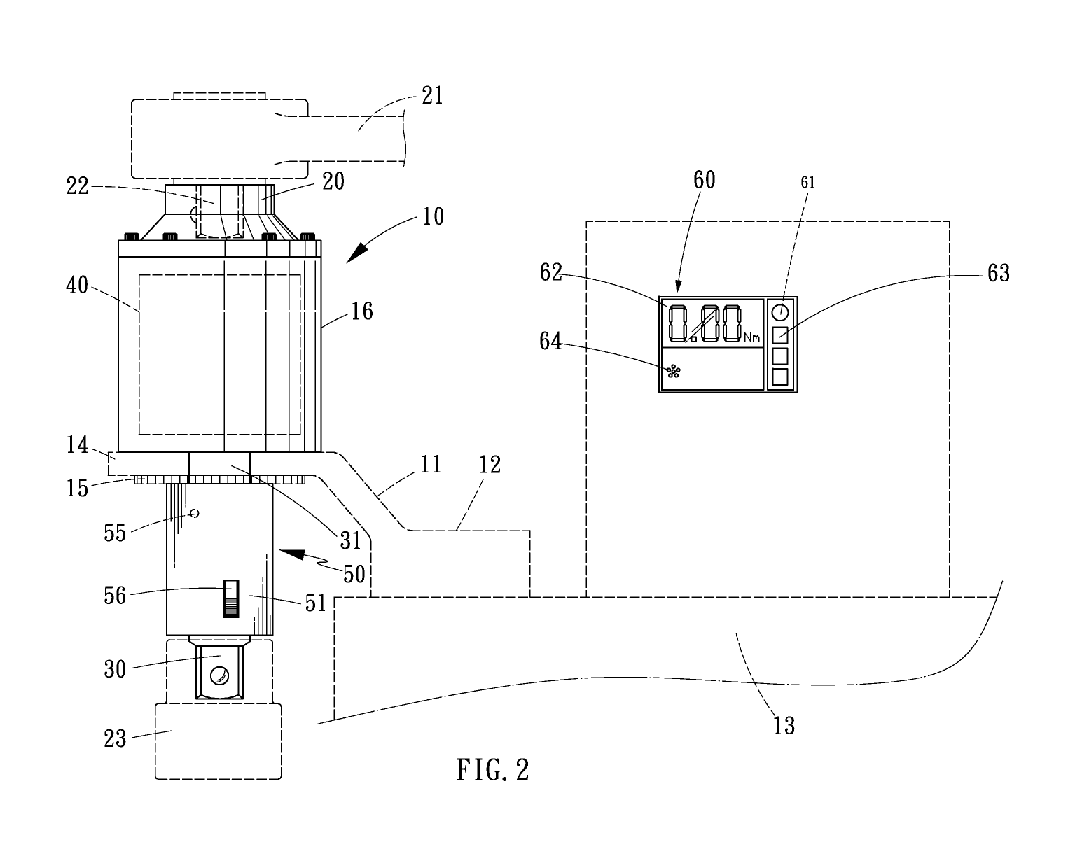

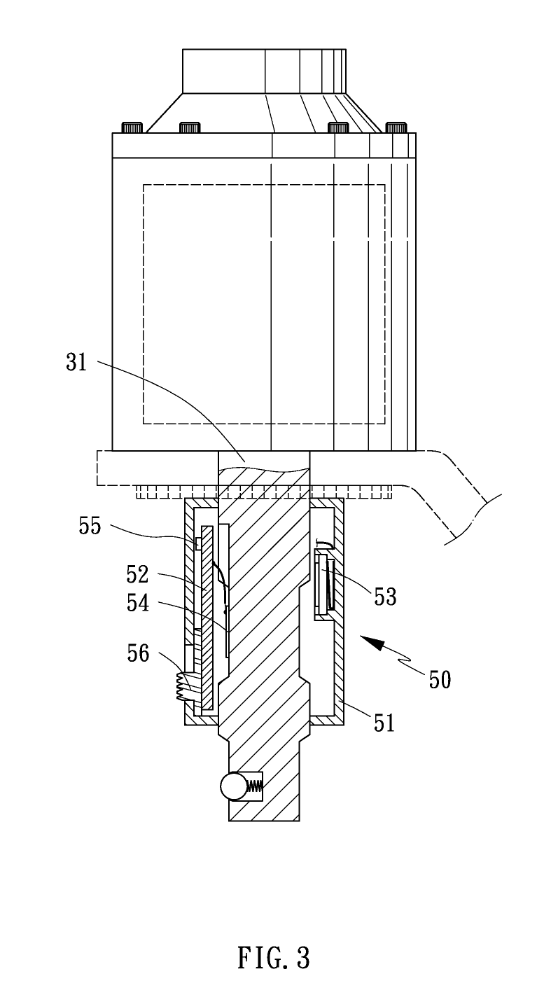

Referring to FIGS. 1 to 3, there is a torque multiplier 10 according to the preferred embodiment of the present invention. The torque multiplier 10 includes a shell 16, an input element 20, an output element 30, a multiplying unit 40, a measurement unit 50 and a display 60. The shell 16 is used to contain both of the input element 20 and the multiplying unit 40.

The input element 20 includes a cavity for receiving a tongue 22 of a wrench 21. The output element 30 includes an axle 31 for insertion in a cavity of a socket 23. The multiplying unit 40 includes an end connected to the input element 20 and another end connected to the output element 30 via an axle 31. The torque measurement unit 50 is attached to the shell 16.

The multiplying unit 40 is preferably a planetary gear train. In such a case, the shell 16 is made a ring gear. The multiplying unit 40 will not be further described in detail for being conventional.

The measurement unit 50 includes a casing 51, a circuit board 52, a battery 53, a sensor 54, a wireless transmitter 55 and a switch 56. The casing 51 is attached to the axle 31. The casing 51 is used to contain the circuit board 52, the battery 53, the sensor 54 and the wireless transmitter 55. The circuit board 52 is electrically connected to the battery 53, the sensor 54, the wireless transmitter 55 and the switch 56. The battery 53 can be replaced with a new one. The sensor 54 is further connected to the axle 31 so that the sensor 54 senses the deformation of the axle 31 when the torque is transmitted via the axle 31. The sensor 54 is preferably a strain gauge. The switch 56 is operable to turn the measurement unit 50 on or off.

The display 60 includes a wireless receiver 61, a screen 62, several buttons 63 and a siren 64. Although not shown, it should be understood that the display 60 includes a circuit board electrically connected to the wireless receiver 61, the screen 62, the buttons 63 and the siren 64. One of the buttons 63 is operable to select from unit systems for the value of the torque for example. Another one of the buttons 63 is operable to set a limit for the value of the torque for example.

In use, the shell 16, as a ring gear, must be kept in position, i.e., not rotated. Hence, there is a bracket 11 for non-rotationally connecting the shell 16 to a stationary object 13 such as a table. An end 14 of the bracket 11 is connected to the shell 16 via a nut 15. Another end 12 of the bracket 11 is connected to the stationary object 13 by a threaded bolt (not shown). The tongue 22 of the wrench 21 is inserted in the cavity of input element 20. The axle 31 of the output element 30 is inserted in the cavity of the socket 23. The socket 23 is used to receive a nut or a head of a threaded bolt. The wrench 21 is operated to exert torque on the nut or the head of the threaded bolt.

The sensor 54 senses the deformation of the axle 31 and accordingly sends an original signal to the circuit board 52. Based on the original signal, the circuit board 52 calculates the value of the torque and instructs the wireless transmitter 55 to transmit a wireless signal.

The wireless receiver 61 receives the wireless signal and accordingly sends a secondary signal to the circuit board of the display 60. Based on the secondary signal, the circuit board of the display 60 determines the value of the torque and instructs the screen 62 to show the value of the torque. Moreover, the circuit board of the display 60 actuates the siren 64 when the value of the torque exceeds a predetermined limit set by operating at least one of the buttons 63.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A torque multiplier including:
an input element for connection to a tool operable for exerting torque;
an output element for connection to an object to be driven by the tool;
a multiplying unit for connecting the input element to the output element and turning a lower value of torque at the input element to a higher value of torque at the output element;
a measurement unit for measuring the higher value of torque and accordingly sending a wireless signal; and
a display for receiving the wireless signal and accordingly showing the higher value of torque.

2. The torque multiplier according to claim 1, including an axle connected to the multiplying unit at an end and connected to the output element at another end.

3. The torque multiplier according to claim 2, wherein the measurement unit is connected to the axle.

4. The torque multiplier according to claim 3, wherein the measurement unit includes:
a casing connected to the axle;
a circuit board placed in the casing;
a sensor electrically connected to the circuit board and connected to the axle; and
a wireless transmitter for sending the wireless signal under the control of the circuit board.

5. The torque multiplier according to claim 4, wherein the measurement unit includes a switch electrically connected to the circuit board and supported on the casing.

6. The torque multiplier according to claim 4, wherein the display includes:
a wireless receiver for receiving the wireless signal; and
a screen for showing the higher value of torque based on the wireless signal.

7. The torque multiplier according to claim 6, wherein the display includes at least one button operable for selecting from several unit systems for the higher value of torque.

8. The torque multiplier according to claim 6, wherein the display includes a siren for sending warning sound when the higher value of torque reaches a limit.

9. The torque multiplier according to claim 1, including a shell for containing the input element and the multiplying unit.
